(19) United States
(12) Patent Application Publication
(10) Pub. No.: US 2004/0238009 A1
(43) Pub. Date: Dec. 2, 2004

(54) Cleaning equipment and use thereof

(76) Inventors: Henrik Falster-Hansen, Tollose (DK); Rene Vinther Elgaard, Hornbaek (DK)

Correspondence Address: WILLIAM J. SAPONE, COLEMAN SUDOL SAPONE P.C., 714 COLORADO AVENUE, BRIDGE PORT, CT, 06605, US

(21) Appl. No.: 10/488,829

(22) PCT Filed: Sep. 5, 2002
(86) PCT No.: PCT/DK02/00575

(30) Foreign Application Priority Data
Sep. 7, 2001 (DK) PA 2001 01319

(51) Int. Cl. B08B 9/00

(52) U.S. Cl. 134/22.1; 134/166 R; 134/172; 134/198

(57) ABSTRACT

By constructing tank cleaning equipment according to the invention such that it comprises a cleaning jetting part (7, 9) as well as a suction part (4), the equipment can work with the same cleaning medium which is recirculated. This saves supply of fresh cleaning medium, and since used medium is thus not discharged, it is not necessary to establish deposit facilities to avoid pollution. Furthermore, this equipment according to the invention may advantageously be used for keeping so-called drilling mud in a mixed and thus ready-to-use state, even when left to stand for an extended period of time in a tank. The nozzle jets (10) thus keep the mud in the tank in a constantly mixed state, and the mud can therefore be sucked through the suction pipe (20) for pumping in the drill pipe, it being ensured that the mud is homogeneous and has a suitable viscosity.

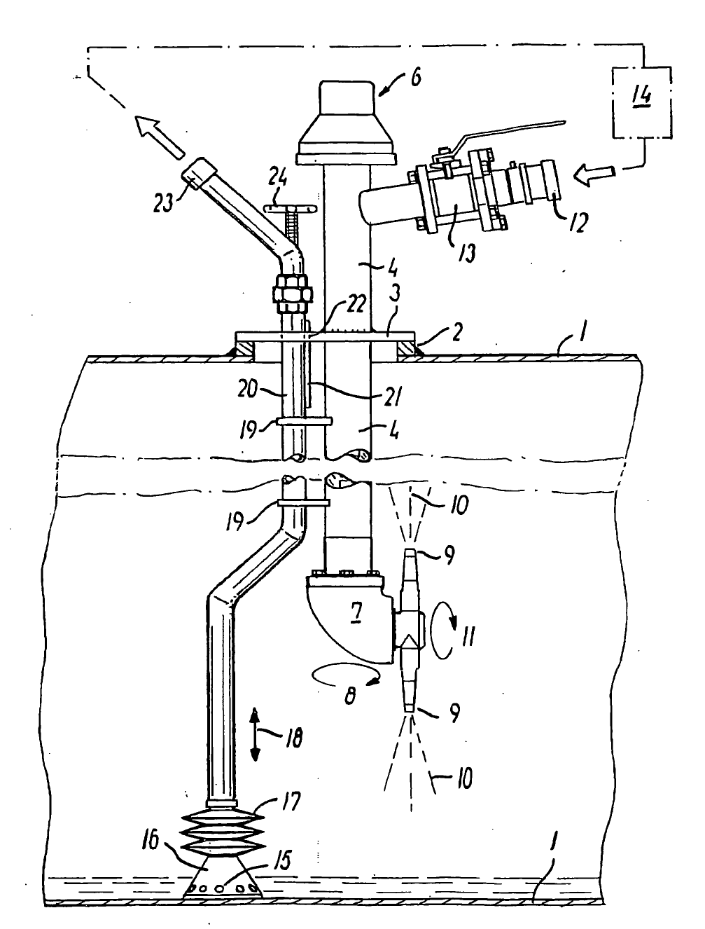

### STATE OF THE ART

The invention relates to cleaning equipment for the cleaning of a tank space by means of pipe lowered into the tank space with cleaning equipment comprising a revolving cleaning head with rotating nozzles, and from which cleaning medium is discharged, as well as use of the equipment.

Cleaning equipment of this type is used in particular for the cleaning of various forms of tank spaces for use in process technology, the food industry as well as storage tanks.

Cleaning takes place by means of flushing from rotating and revolving nozzles so that the entire internal surface of the tank space is flushed. Material settled on the tank wall and the cleaning medium must subsequently be pumped out and collected. This cleaning medium with suspended material is frequently a problem, since it must be stored for subsequent cleaning in order to avoid pollution. To this should be added that this cleaning process must be supplied with an uninterrupted flow of cleaning medium, which requires a considerable amount of cleaning liquid.

This is a drawback where limited amounts of cleaning medium are available, such as on drilling platforms and similar locations, just as it requires a sufficient tank capacity for the storage of the cleaning medium pumped out.

### OBJECT OF THE INVENTION

The object of the invention is to remedy these drawbacks and defects, and this is achieved according to the invention by cleaning equipment, where the cleaning equipment additionally comprises a suction pipe extending from the bottom of the tank space and out of the tank space, said suction pipe being connected with the suction side of a pump, while the delivery side of the pump is connected with the nozzles of the cleaning head.

Cleaning of tank spaces may be carried out in this surprisingly simple manner by recirculating the cleaning medium. In this manner, the amount of cleaning medium is limited, and the problem of discharging polluted medium is effectively remedied, since the cleaning medium may be re-used.

If the cleaning medium is cleaned, e.g. in that coarse particles are filtered off in a filter, the cleaning medium may be re-used several times.

When, as stated in claim 2, the equipment is constructed such that it may be mounted in one and the same hole in the tank, the installation is very compact, and the mounting is therefore simpler and less expensive.

When, as stated in claim 3, the suction pipe is constructed such that it may be adjusted in height from the outside, the same equipment may be adapted to various tank dimensions. When, as stated in claim 4, the cleaning medium is recirculated, it may be used in locations where a limited amount of cleaning medium is available, and where discharge of polluted cleaning medium is not allowed.

Finally, it is expedient, as stated in claim 5, to use the equipment to ensure a homogeneous and fluid drilling mud which is used for lubrication and pressure seal-off around the drill in the drill pipe.

### THE DRAWING

An example of an embodiment of the equipment according to the invention will be described more fully below with reference to the drawing, which shows a section through a tank with the equipment mounted.

### DESCRIPTION OF THE EXAMPLE OF AN EMBODIMENT

The drawing shows an example of a preferred embodiment of the equipment according to the invention.

The tank in which the equipment is mounted is indicated with an upper and lower tank wall 1.

The top of the tank is formed with a hole at which a flange 2 is mounted.

A cover 3 is secured to this flange 2. Where the equipment is not mounted, the cover is a so-called closed cover, which is fixedly bolted in a generally known manner.

When the cleaning equipment is to be mounted, the cover is removed, and the cover 3 shown in the drawing is mounted, through which a cleaning pipe 4 as well as a suction pipe 20 may be passed.

The cleaning pipe 4 is normally welded to the cover 3, protruding a distance above the cover and such that a drive means (not shown) for a coupling member 6 may be mounted

Furthermore, a supply stub 12 for the supply of cleaning medium under pressure is provided.

A valve 13 controls the supply of this medium.

The cleaning pipe 4 internally mounts a drive shaft which, via the drive equipment, can revolve the cleaning head 7 mounted at the end such that the cleaning head revolves as indicated by an arrow 8.

The cleaning head 7 is moreover provided with rotating nozzles 9 which rotate in the direction of the arrow 11 during cleaning at the same time as the cleaning head revolves.

The cleaning medium is fed to the pipe 4 and is discharged through the nozzles 9 to form the cleaning jets 10.

When cleaning takes place, the cleaning head revolves while the nozzles rotate, which results in a great cleaning effect and provides the certainty that all internal faces are swept uniformly by the cleaning medium.

Also a suction pipe 20 is passed through the cover and is mounted with a longitudinal key 21 secured at the side and extending in a keyway 22 in the cover 3. In addition, a plurality of guides 19 for the suction pipe 20 are secured on the cleaning pipe 4.

A raising/lowering system e.g. in the form of a spindle 24 is mounted such that the suction pipe 20 may be displaced relative to the cover and thereby relative to the tank space.

The purpose of this height adjustability is to adjust the suction end of the suction pipe 20 relative to the bottom of the tank.

As indicated in the drawing, a bellows member 17 may be mounted for accommodating any movement in the longitudinal direction, just as a hopper 16 with inlet holes 15 on the circumference is mounted.

The suction pipe 20 protrudes a distance above the cover 3 and is provided with a hose coupling member 23 at the end.

By means of this, a suction hose may be connected to a pump 14, said pump being connected with the cleaning pipe 4 at the delivery side, so that cleaning medium may be discharged via the nobles 9 into the tank space.

The cleaning medium will be recirculated in a completely closed circuit during the cleaning.

As needed, a filter arrangement (not shown) may be inserted in a generally known manner between the suction side and the delivery side so that at least a coarse filtration takes place.

In this manner, the same cleaning medium may be re-used, thereby obviating the need for a constant supply of fresh cleaning medium and also the need for collection/discharge of used and dirty cleaning medium.

Moreover, it has been found that the equipment is extremely suitable for use in tanks in which so-called drilling mud is stored.

This drilling mud consists of clay and specially developed chemicals which are mixed with water and/or oil.

It is used for lubricating the movable parts of the drill head and for flushing the loosened subsoil material away from the drill head. It moreover forms a sealing layer between the drill and the drill pipe when it is pumped in the drill pipe.

The problem of this drilling mud is that at standstill it tends to disintegrate into components where the heavy parts will precipitate. The drilling mud cannot be used in this state, as it functions only when it is in a homogeneous state.

It has surprisingly been found that the drilling mud may advantageously be deposited in a tank in which equipment corresponding to the cleaning equipment described above is mounted.

In this use, mixing water/oil must be supplied to the cleaning equipment, which will keep the drilling mud suitably mixed and conditioned by its nozzle movement. At the same time, drilling mud ready for use may be sucked out via the suction pipe, and may then be pumped down into the drill pipe, the drill string.

This saves a considerable amount of work, as the mixed drilling mud, which is left to stand for an extended period of time, may be kept mixed and ready for use.

1. Cleaning equipment for the cleaning of a tank space by means of a pipe lowered into the tank space with the cleaning equipment comprising a revolving cleaning head with rotatable nozzles, and from which cleaning medium is discharged, characterized in that the cleaning equipment additionally comprises a suction pipe (20) extending from the bottom of the tank space and out of the tank space, said cleaning pipe (20) being connected with the suction side of a pump (14), while the delivery side of the pump is connected with the nozzles (9) of the cleaning head (7).

2. Cleaning equipment according to claim 1, characterized in that both the suction pipe (20) and the lowered pipe (4) of the cleaning equipment extend through the same opening in the tank wall (1).

3. Cleaning equipment according to claims 1 end 2 claim 1, characterized in that the suction pipe (20) is provided with means (24) for height adjustment (18) of the inlets (15, 16) of the suction pipe (20) into the tank space.

4. (Cancelled).

5. (Cancelled).

6. The cleaning equipment according to claim 2 characterized in that the suction pipe (20) is provided with means (24) for height adjustment (18) of the inlets (15, 16) of the suction pipe (20) into the tank space.

7. A method for cleaning a tank space comprising lowering a pipe into the tank space, the pipe having a revolving cleaning head with rotatable nozzles, extending a suction pipe from a bottom of the tank space and out of the tank space, connecting the cleaning pipe to a suction side of a pump, connecting a delivery side of the pump to the nozzles of the cleaning head and cleaning the tank space by recirculating a cleaning medium therein.

8. A method for preparing drilling mud for use in drill pipes for extracting oil and gas comprising lowering a pipe into a tank space, the pipe having a revolving head with rotatable nozzles, extending a suction pipe from a bottom of the tank space and out of the tank space, connecting the pipe to a suction side of a pump, connecting a delivery side of the pump to the nozzles of the head and delivering a liquid medium thereto and discharging the drilling mud from the delivery side of the pump while the head receives the liquid, the nozzles discharging the liquid in the tank, keeping the mud mixture mixed.
